(19) United States
(12) Patent Application Publication
(10) Pub. No.: US 2025/0348397 A1
(43) Pub. Date: Nov. 13, 2025

(54) POWER MANAGEMENT METHOD AND POWER MANAGEMENT DEVICE

(71) Applicant: ASUSTEK COMPUTER INC., TAIPEI (TW)

(72) Inventors: Chia-Sen CHANG, TAIPEI (TW); Hao-Hsuan LIN, TAIPEI (TW); Ying-Yui WU, TAIPEI (TW); Chiung-Ting YU, TAIPEI (TW); Yu-Hsiu SU, TAIPEI (TW); Chun TSAO, TAIPEI (TW); Chun-Yen LAI, TAIPEI (TW); Wen-Che CHUNG, TAIPEI (TW); Yu-Cheng SHEN, TAIPEI (TW); Shih-Hsiang KAO, TAIPEI (TW); Wen-Ling WONG, TAIPEI (TW); Yan-Xian GUO, TAIPEI (TW)

(21) Appl. No.: 18/819,526

(22) Filed: Aug. 29, 2024

(30) Foreign Application Priority Data
May 9, 2024 (TW) 113117197

(51) Int. Cl. G06F 11/30; G06F 1/3206

(52) U.S. Cl. CPC G06F 11/3058; G06F 1/3206; G06F 11/3055; G06F 2201/805

(57) ABSTRACT

A power management method is provided. The power management method is applicable to an electronic device. The electronic device includes a processor, and includes an operating system installed therein. The operating system is configured with a first working mode and a second working mode. Power consumption corresponding to the second working mode is less than power consumption corresponding to the first working mode. The power management method includes: setting a plurality of usage scenarios with different power consumption settings; receiving an enabling instruction; monitoring a state of the processor to generate state data and notifying the operating system to operate in the second working mode, in response to the enabling instruction; and selecting one of the plurality of usage scenarios based on the state data, and managing power consumption of the electronic device based on the selected usage scenario. A power management device is further provided.

### CROSS-REFERENCE TO RELATED APPLICATION

This application claims the priority benefit of Taiwan Application Serial No. 113117197, filed on May 9, 2024. The entirety of the above-mentioned patent application is hereby incorporated by reference herein and made a part of specification.

### BACKGROUND OF THE INVENTION

### Field of the Invention

The disclosure relates to a power management method and a power management device, and in particular, to a power management method and a power management device applicable to an electronic device.

### Description of the Related Art

Operating systems currently installed on portable electronic devices generally include an energy-saving mode for manual selection or setting by users. The selection of the energy-saving mode achieves an effect of prolonging a battery life. However, a low efficiency setting of the energy-saving mode brings non-smoothness or freezing during operation of the users, resulting in poor user experience.

### BRIEF SUMMARY OF THE INVENTION

The disclosure provides a power management method. The power management method is applicable to an electronic device. The electronic device includes a processor, and includes an operating system installed therein. The operating system is configured with a first working mode and a second working mode. Power consumption corresponding to the second working mode is less than power consumption corresponding to the first working mode. The power management method includes: setting a plurality of usage scenarios with different power consumption settings; receiving an enabling instruction; monitoring a state of the processor to generate state data and notifying the operating system to operate in the second working mode, in response to the enabling instruction; and selecting one of the plurality of usage scenarios based on the state data, and managing power consumption of the electronic device based on the selected usage scenario.

The disclosure further provides a power management device. The power management device is applicable to an electronic device. The electronic device includes a processor, and includes an operating system installed therein. The operating system is configured with a first working mode and a second working mode. Power consumption corresponding to the second working mode is less than power consumption corresponding to the first working mode. The power management device includes a setting unit and a control unit. The setting unit is configured with a plurality of usage scenarios with different power consumption settings. The control unit is configured to: set a plurality of usage scenarios with different power consumption settings; receive an enabling instruction; monitor a state of the processor to generate state data and notify the operating system to operate in the second working mode, in response to the enabling instruction; and select one of the plurality of usage scenarios based on the state data, and manage power consumption of the electronic device based on the selected usage scenario.

According to the power management method and the power management device provided in the disclosure, the plurality of usage scenarios and corresponding power management information are preset, and a proper usage scenario is selected based on the state data of the processor, to manage power consumption of the electronic device. In this way, relevant efficiency and power settings are dynamically adjustable based on different usage scenarios, thereby alleviating non-smoothness or freezing during operation of a user as a result of a low efficiency setting of an energy-saving mode.

### BRIEF DESCRIPTION OF THE DRAWINGS

FIG. 1 is a schematic block diagram of a power management device according to an embodiment of the disclosure;

FIG. 2 is a schematic block diagram of a power management device according to another embodiment of the disclosure;

FIG. 3 is a flowchart of a power management method according to an embodiment of the disclosure; and

FIG. 4 is a flowchart of a power management method according to another embodiment of the disclosure.

### DETAILED DESCRIPTION OF THE EMBODIMENTS

Specific embodiments of the disclosure are described in more details below with reference to the schematic diagrams. Advantages and features of the disclosure become clearer based on the following descriptions and claims. It is to be noted that all figures are in a very simple form and in an inaccurate proportion, and are merely intended to assist in convenient and clear description of the embodiments of the disclosure.

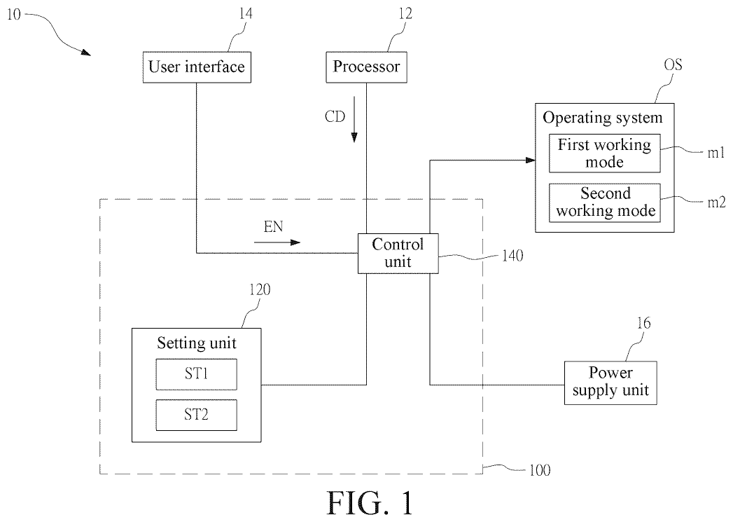

FIG. 1 is a schematic block diagram of a power management device 100 according to an embodiment of the disclosure. The power management device 100 is applicable to an electronic device 10. The electronic device 10 includes a processor 12, a user interface 14, and a power supply unit 16, and includes an operating system OS installed therein. The operating system OS is configured with a first working mode m1 and a second working mode m2. Power consumption corresponding to the second working mode m2 is less than power consumption corresponding to the first working mode m1.

The electronic device 10 is a desktop computer, a laptop computer, a main board component, or another electronic device 10 equipped with a processor 12 for computing and including an operating system OS installed therein for operation by a user. In an embodiment, the electronic device 10 is a portable electronic device.

The first working mode m1 and the second working mode m2 are preset working modes in the operating system OS. In an embodiment, the first working mode m1 is an efficiency mode, and the second working mode m2 is a balance mode.

The processor 12 is a central processing unit (CPU). However, the disclosure is not limited thereto. In other embodiments, the processor 12 is a graphics processing unit (GPU), a neural processing unit (NPU), or a tensor processing unit (TPU).

The power management device 100 includes a setting unit 120 and a control unit 140. The setting unit and the control unit are configured to execute a dynamic power adjustment mode when the electronic device 10 is in a direct current (DC) mode. The setting unit 120 is configured with a plurality of usage scenarios ST1 and ST2. The usage scenarios ST1 and ST2 include different power consumption settings, such as an efficiency setting (such as a working frequency and a working temperature of the processor 12) and a power setting (such as a total power supply wattage of the power supply unit 16 or a power supply wattage for a specific element). In this embodiment, the two usage scenarios ST1 and ST2 are described, but the disclosure is not limited thereto. More types of usage scenarios are set based on an actual need.

In an embodiment, the setting unit 120 is a basic input/output system (BIOS) or is arranged in the BIOS. In another embodiment, power consumption settings corresponding to the usage scenarios ST1 and ST2 are set by a user.

The control unit 140 is electrically coupled to the setting unit 120. The control unit 140 is configured to receive an enabling instruction EN inputted from outside. After receiving the enabling instruction EN, the control unit 140 starts to monitor a state of the processor 12, and notifies the operating system OS to operate in the second working mode m2. In other words, after receiving the enabling instruction EN, the control unit 140 notifies the operating system OS to operate in the second working mode m2 with lower power consumption.

Subsequently, the control unit 140 selects one of the plurality of usage scenarios ST1 and ST2 preset in the setting unit 120 based on state data CD generated based on the monitored state of the processor 12, and manages power consumption of the electronic device 10 through the power supply unit 16 based on the selected usage scenario ST1 or ST2.

In an embodiment, the control unit 140 manages power consumption of the electronic device 10 by adjusting a setting of a power limit of the CPU and a setting of a device power state. In an embodiment, the control unit 140 includes an embedded controller (EC).

In an embodiment, it is assumed that the CPU has power limit levels PL1, PL2, PL3, and PL4 (in ascending order) defined therein. PL1 corresponds to a thermal design power (TDP) of the CPU, and supports long time operation. PL2, PL3, and PL4 are power limits supporting short time exceeding. In the dynamic power adjustment mode, the power limit levels PL1, PL2, PL3, and PL4 are forcibly adjustable to lower power consumption values.

In an embodiment, the device power state is defined with states D1, D2, D3, D4, and D5 in descending order. In the dynamic power adjustment mode, the device power states D1, D2, and D3 are forcibly adjustable to the device power state D4.

In an embodiment, if the processor 12 is a CPU, corresponding state data CD includes a frequency, a temperature, and power consumption. In an embodiment, if the processor 12 is a GPU, corresponding state data CD includes a frequency, a temperature, power consumption, and an enabling state.

In an embodiment, the electronic device 10 further includes a user interface 14, and the control unit 140 receives the enabling instruction EN through the user interface 14. In an embodiment, the user interface 14 includes an input device, such as a keyboard, a touchpad, or a touchscreen. The input device receives a control signal inputted by the user, and then generates the enabling instruction EN and provides the enabling instruction to the control unit 140.

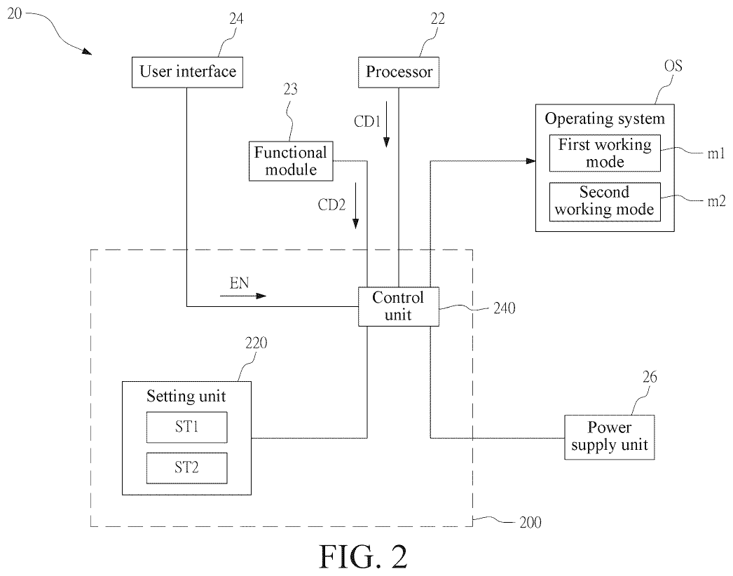

FIG. 2 is a schematic block diagram of a power management device 200 according to another embodiment of the disclosure. The power management device 200 is applicable to an electronic device 20. The electronic device 20 includes a processor 22, a functional module 23, a user interface 24, and a power supply unit 26. In an embodiment, the processor 22 is a CPU, and the functional module 23 is a GPU. The electronic device 20 includes an operating system OS installed therein. The operating system OS is configured with a first working mode m1 and a second working mode m2. Power consumption corresponding to the second working mode m2 is less than power consumption corresponding to the first working mode m1.

The first working mode m1 and the second working mode m2 are preset working modes in the operating system OS. In an embodiment, the first working mode m1 is an efficiency mode, and the second working mode m2 is a balance mode.

The power management device 200 includes a setting unit 220 and a control unit 240. The setting unit 220 is configured with a plurality of usage scenarios ST1 and ST2. The plurality of usage scenarios ST1 and ST2 include different power consumption settings. In an embodiment, the setting unit 220 is a BIOS or is arranged in the BIOS.

The control unit 240 is electrically coupled to the setting unit 220. The control unit 240 is configured to receive an enabling instruction EN inputted from outside. After receiving the enabling instruction EN, the control unit 240 starts to monitor states of the processor 22 (that is, the CPU) and the functional module 23 (that is, the GPU), and notifies the operating system OS to operate in the second working mode m2.

Subsequently, the control unit 240 selects one of the plurality of usage scenarios ST1 and ST2 preset in the setting unit 220 based on first state data CD1 generated based on the monitored state of the processor 22 (that is, the CPU) and second state data CD2 generated based on the monitored state of the functional module 23 (that is, the GPU), and manages details of power consumption of the electronic device 10 based on the selected usage scenario ST1 or ST2.

In an embodiment, the plurality of usage scenarios ST1 and ST2 includes a document processing usage scenario. When the second state data CD2 generated by the control unit 240 by monitoring the state of the functional module 23 (that is, the GPU) indicates that the functional module 23 (that is, the GPU) is not enabled, the control unit 240 selects the document processing usage scenario to manage power consumption of the electronic device 20. In the document processing usage scenario, a power supply setting corresponding to the functional module 23 (that is, the GPU) is set to no power supply.

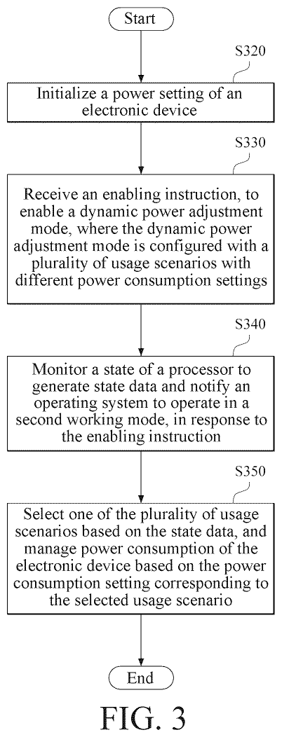

FIG. 3 is a flowchart of a power management method according to an embodiment of the disclosure. The power management method is applicable to an electronic device 10. The electronic device 10 includes a processor 12, and includes an operating system OS installed therein. The operating system OS is configured with a first working mode m1 and a second working mode m2. Power consumption corresponding to the second working mode m2 is less than power consumption corresponding to the first working mode m1. The power management method includes the following steps.

First, as described in step S320, a power setting of the electronic device 10 is initialized.

Subsequently, as described in step S330, an enabling instruction EN is received, to enable a dynamic power adjustment mode, where the dynamic power adjustment mode is configured with a plurality of usage scenarios ST1 and ST2. The plurality of usage scenarios ST1 and ST2 include different power consumption settings.

Then, as described in step S340, a state of the processor 12 is monitored to generate state data CD and the operating system OS is notified to operate in the second working mode m2, in response to the enabling instruction EN.

Next, as described in step S350, one of the plurality of usage scenarios ST1 and ST2 is selected based on the state data CD, and power consumption of the electronic device 10 is managed based on the power consumption setting corresponding to the selected usage scenario ST1 or ST2.

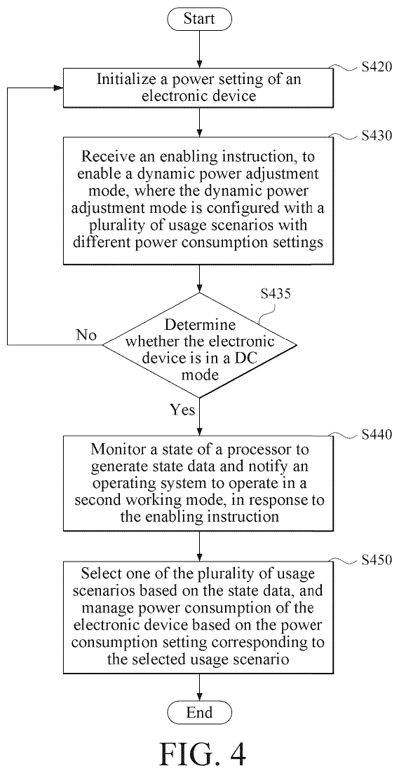

FIG. 4 is a flowchart of a power management method according to another embodiment of the disclosure.

First, as described in step S420, settings of an efficiency mode and of a working mode of a processor 12 are initialized. The step is to recover an original power setting.

As described in step S430, an enabling instruction EN is received, to enable a dynamic power adjustment mode, where the dynamic power adjustment mode is configured with a plurality of usage scenarios ST1 and ST2. The plurality of usage scenarios ST1 and ST2 include different power consumption settings.

Subsequently, as described in step S435, it is determined whether an electronic device 10 is in a DC mode.

When it is determined that the electronic device 10 is in the DC mode, the process proceeds to step S440. As described in step S440, a state of the processor 12 is monitored to generate state data CD and the operating system OS is notified to operate in the second working mode m2, in response to the enabling instruction EN.

If the electronic device 10 is not in the DC mode, in an embodiment, is in an alternating current (AC) mode, the process returns to step S420. To be specific, the settings of the efficiency mode and the working mode of the processor 12 before the enabling of the dynamic power adjustment mode are recovered. In an embodiment, the efficiency mode is recovered.

Next, as described in step S450, one of the plurality of usage scenarios ST1 and ST2 is selected based on the state data CD, and power consumption of the electronic device 10 is managed based on the power consumption setting corresponding to the selected usage scenario ST1 or ST2.

Compared to the embodiment of FIG. 3, in this embodiment, after step S430 of receiving the enabling instruction EN, a determination step S435 of determining whether the electronic device 10 is in the DC mode is performed.

When the electronic device 10 is in the DC mode, the process proceeds to step S440 of monitoring the state of the processor 12 to generate the state data CD and notifying the operating system OS to operate in the second working mode m2.

Other steps such as steps S420, S430, S440, and S450 in this embodiment are similar to the corresponding steps S320, S330, S340, and S350 in the embodiment of FIG. 3, and therefore are not described in detail herein.

According to the power management method and the power management device 100 or 200 provided in the disclosure, the plurality of usage scenarios ST1 and ST2 and corresponding power management information are preset, and a proper usage scenario is selected based on the state data CD of the processor 12, to manage power consumption of the electronic device 10 or 20. In this way, relevant efficiency and power mode settings are dynamically adjustable based on different usage scenarios ST1 and ST2, thereby alleviating non-smoothness or freezing during operation of a user as a result of a low efficiency setting of an energy-saving mode.

The above is merely preferred embodiments of the disclosure, and does not impose any limitation on the disclosure. Any form of change such as an equivalent replacement or modification made by any person skilled in the art to technical means and technical content disclosed in the disclosure without departing from scope of the technical means of the disclosure is content that does not deviate from the technical means of the disclosure, and still falls within protection scope of the disclosure.

What is claimed is:

1. A power management method, applicable to an electronic device, wherein the electronic device comprises a processor, and comprises an operating system installed therein, the operating system is configured with a first working mode and a second working mode, power consumption corresponding to the second working mode is less than power consumption corresponding to the first working mode, and the power management method comprises:
receiving an enabling instruction, to enable a dynamic power adjustment mode, wherein the dynamic power adjustment mode is configured with a plurality of usage scenarios with different power consumption settings;
monitoring a state of the processor to generate state data and notifying the operating system to operate in the second working mode, in response to the enabling instruction; and
selecting one of the plurality of usage scenarios based on the state data, and managing power consumption of the electronic device based on the power consumption setting corresponding to the selected usage scenario.

2. The power management method according to claim 1, wherein the electronic device is a portable electronic device.

3. The power management method according to claim 1, wherein the first working mode is an efficiency mode, and the second working mode is a balance mode.

4. The power management method according to claim 1, wherein the processor is a central processing unit (CPU).

5. The power management method according to claim 4, wherein the state data comprises a frequency, a temperature, and power consumption.

6. The power management method according to claim 1, wherein the processor is a graphics processing unit (GPU).

7. The power management method according to claim 6, wherein the state data comprises a frequency, a temperature, power consumption, and an enabling state.

8. The power management method according to claim 7, wherein the plurality of usage scenarios comprises a document processing usage scenario, and a power supply setting corresponding to the GPU is set to no power supply in the document processing usage scenario.

9. The power management method according to claim 8, wherein when the state data indicates that the GPU is not enabled, the document processing usage scenario is selected to manage power consumption of the electronic device.

10. The power management method according to claim 1, wherein after the step of receiving the enabling instruction, the method further comprises: determining whether the electronic device is in a direct current (DC) mode, and notifying the operating system to operate in the second working mode when the electronic device is in the DC mode.

11. A power management device, applicable to an electronic device, wherein the electronic device comprises a processor, and comprises an operating system installed therein, the operating system is configured with a first working mode and a second working mode, power consumption corresponding to the second working mode is less than power consumption corresponding to the first working mode, and the power management device comprises:
a setting unit, configured with a plurality of usage scenarios with different power consumption settings; and
a control unit, configured to:
receive an enabling instruction;
monitor a state of the processor to generate state data and notify the operating system to operate in the second working mode, in response to the enabling instruction; and
select one of the plurality of usage scenarios based on the state data, and manage power consumption of the electronic device based on the power consumption setting corresponding to the selected usage scenario.

12. The power management device according to claim 11, wherein the electronic device comprises a user interface, and the control unit is configured to receive the enabling instruction through the user interface.

13. The power management device according to claim 11, wherein the setting unit is a basic input/output system (BIOS).
